(19) United States
(12) Patent Application Publication
(10) Pub. No.: US 2008/0026164 A1
(43) Pub. Date: Jan. 31, 2008

(54) GLOW-IN-THE-DARK GAZING GLOBES AND OTHER ORNAMENTS, PARTICULARLY FOR GARDENS

(76) Inventor: Richard Cohen, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/834,320

(22) Filed: Aug. 6, 2007

Related U.S. Application Data
(63) Continuation-in-part of application No. 10/833,219, filed on Apr. 27, 2004, now Pat. No. 7,252,889.
(60) Provisional application No. 60/466,105, filed on Apr. 28, 2003.

(51) Int. Cl. B44F 7/00; H01J 9/227

(52) U.S. Cl. 428/13; 156/67

(57) ABSTRACT

A method of fabricating glow-in-the-dark gazing globes or other objects, as well as the articles that result. The method comprises the steps of providing a hollow form having an inner wall made from a transparent or translucent material, the form including an aperture for gaining access to the interior thereof, and introducing one more photoluminescence or phosphorescent pigments into the form through the aperture so that they cling to the inner wall. In alternative embodiments, the pigments may be applied without an adhesive, as by naturally cling, vacuum evaporation, or other techniques. In a gazing globe embodiment, a stand may be included. In the preferred embodiment the method further includes the step of applying an adhesive to the inner wall of the form prior to the step of introducing one more photoluminescence or phosphorescent pigments. A plurality of different pigments may be introduced into the form to create a decorative or swirling effect.

### REFERENCE TO RELATED APPLICATIONS

This application is a continuation-in-part of U.S. patent application Ser. No. 11/833,219, filed Apr. 27, 2004, which claims priority from U.S. Provisional Patent Application Ser. No. 60/466,105, filed Apr. 28, 2003, the entire content of each application being, incorporated herein by reference.

### BACKGROUNG OF THE INVENTION

This invention relates generally to outdoor ornaments and, in particular, to gazing globes and other decorative objects with ‘glow-in-the-dark’ features.

### BACKGROUND OF THE INVENTION

Garden ornaments such as gazing globes have become very popular as decorative elements in gardens and other outdoor environments. Such items are generally provided as a piece of statuary, including a spherical globe with a highly-polished or reflective surface supported by a base. Existing products typically use glass globes internally mirrored surface tinted in a wide variety of colors.

### SUMMARY OF THE INVENTION

This invention resides in a method of fabricating glow-in-the-dark gazing globes or other objects, as well as the articles that result. The method comprises the steps of providing a hollow form having an inner wall made from a transparent or translucent material, the form including an aperture for gaining access to the interior thereof, and introducing one more photoluminescence or phosphorescent pigments into the form through the aperture so that they cling to the inner wall.

In alternative embodiments, the pigments may be applied without an adhesive, as by naturally cling, vacuum evaporation, or other techniques. In a gazing globe embodiment, a stand may be included. In the preferred embodiment the method further includes the step of applying an adhesive to the inner wall of the form prior to the step of introducing one more photoluminescence of phosphorescent pigments. A plurality of different pigments may be introduced into the form to create a decorative or swirling effect.

According to one specific embodiment of the invention, the pigments are adhesively attached to the inner wall of the form in a pattern that resembles the planet earth.

### BRIEF DESCRIPTION OF THE DRAWINGS

FIG. 1 is a simplified drawing showing the way in which an adhesive may be applied to the inside of a gazing globe;

FIG. 2 is a drawing which shows the way in which a glow-in-the-dark powder may be introduced into the globe of FIG. 1;

FIG. 3 is a drawing which shows the way in which multiple nozzles may be used to introduce multiple particulates;

FIG. 4 is a drawing which shows a finished product on a stand;

FIG. 5 is a drawing that shows a brush used to apply adhesive to create a globe that looks like a planet, such as Earth; and

FIG. 6 shows a finished globe with glow-in-the-dark materials adhered to the adhesive to form a glowing Earth globe.

### DETAILED DESCRIPTION OF THE INVENTION

This invention extends the appeal and usefulness of garden ornaments, including gazing gloves, by providing a glow-in-the-dark product. In the preferred embodiment, one or more phosphorescent or photo luminescent pigments may be used to create a swirling affect or other interesting pattern. However, in an alternative environment, a single or solid coloration is used.

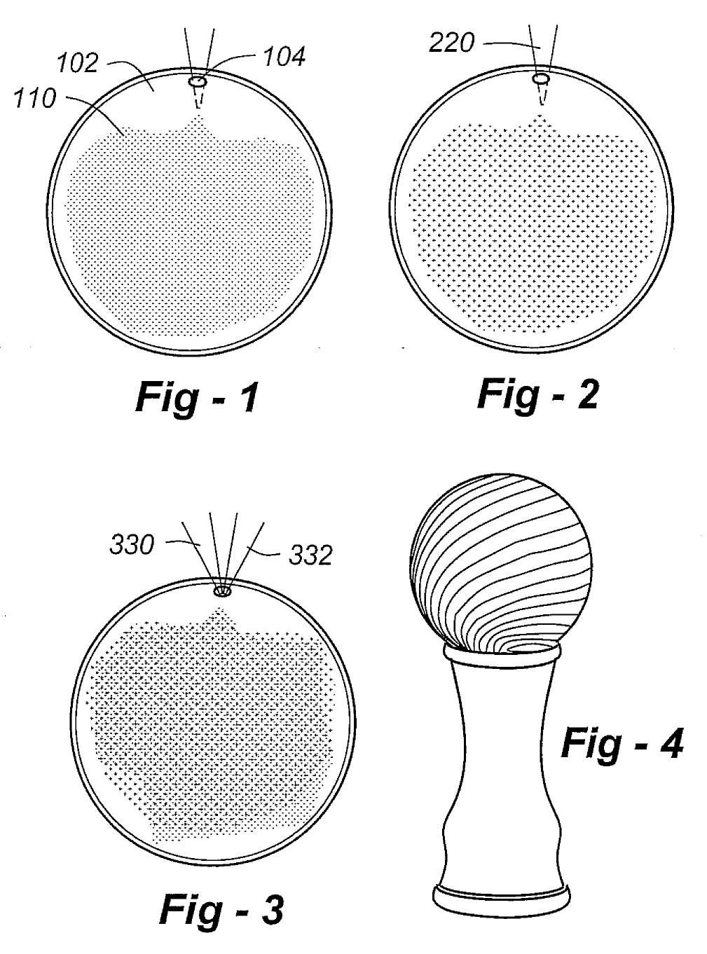

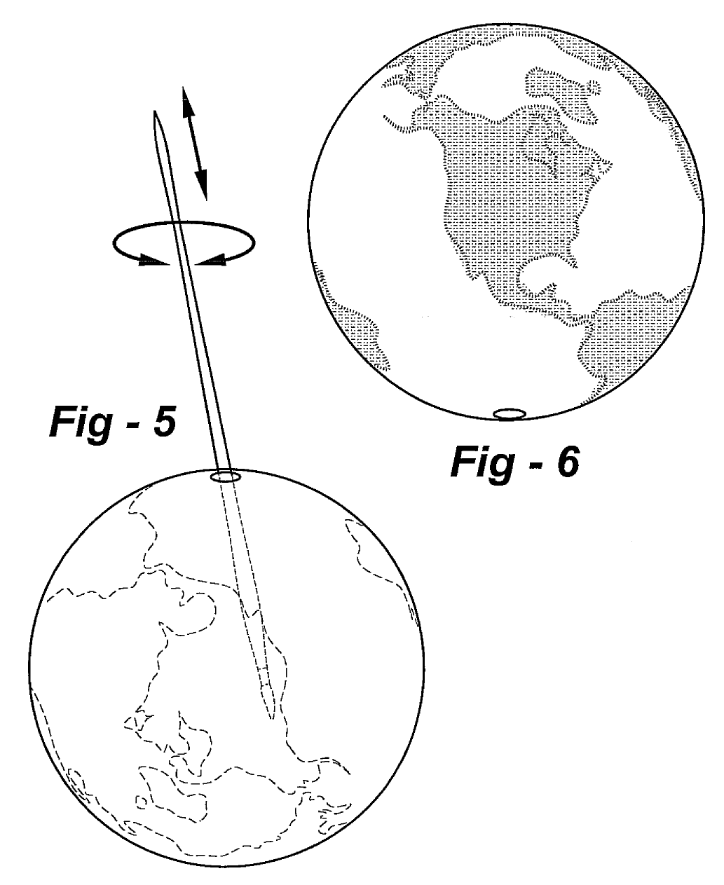

FIG. 1 is a simplified drawing showing the way in which an adhesive may be applied to the inside of a gazing globe. FIG. 2 is a drawing which shows the way in which a glow-in-the-dark powder may be introduced into the globe of FIG. 1. FIG. 3 is a drawing which shows the way in which multiple nozzles may be used to introduce multiple particulates. FIG. 4 is a drawing which shows a finished product on a stand. In terms of manufacture, a clear or at least translucent glass or plastic globe 102 or other object having an opening 104 is first internally coated with an adhesive. The adhesive may be water-bourne or non-water-bourne, may be applied in a spray 110 or atomized form or by brushing, and preferably dries in a transparent form.

While the adhesive coating is still wet or tacky, photo-luminescent or phosphorescent pigments are sprayed on with an atomizer 220 or otherwise introduced so that they become embedded in the adhesive and form an inner coating. Either a single spray head may be used, or multiple spray heads 330, 332 may be used simultaneously or at different times to produce a desired affect. It is also possible to apply the pigments without an adhesive, as by naturally cling, vacuum evaporation, or other techniques. In a gazing globe embodiment, a swirling effect may be created by introducing pigments on an angle or rotating the globe, and/or placed on a vertical stand, as shown in FIG. 4.

Various pigments are applicable to the invention, and they may be combined with other pigments that are not photoactive to create a reflection as well as glow-in-the-dark features. Applicable pigments include alkaline earth metal aluminates such as strontium aluminate, silicate aluminate, or alkaline earth aluminate, with glow colors ranging from green-yellow to purple-blue. Depending upon the mixture, “earth metals” can include strontium, magnesium, calcium, and barium. Silicon and titanium may also be present. It is typically doped with europium. An opaque fluorescent pigment may be added to provide visibility in a brighter environment. As a side effect, the fluorescent pigments also tint the glow which can produce glow colors such as orange. alkaline earth silicate may also be used, which produces a very pure sky blue glow color. Other candidates includes zinc sulfide (with green red, and orange formulations). ZnS:Cu, for example, may be obtained from Pete's Luminous Creations of Singapore.

Although the embodiment described herein utilizes spherical objects, it will be apparent to one of skill in the art that any other shape may be used, so long as access is provided to an internal cavity for the application of adhesive and pigments. As additional examples of many, the invention may accordingly be used to provide glow-in-the-dark animal forms, faux rocks, statues, bird baths, planters and so forth.

FIG. 5 is a drawing that shows a brush used to apply adhesive to create a globe that looks like a planet, such as Earth; and FIG. 6 shows a finished globe with glow-in-the-dark materials adhered to the adhesive to form a glowing Earth globe.

We claim:

1. A method of fabricating a glow-in-the-dark gazing globe, comprising the steps of:
providing a hollow, spherical, transparent or translucent glass form having an interior with an inner wall and an aperture for gaining access to the interior;
applying an adhesive to the inner wall of the form through the aperture to create areas resembling continents on the planet earth; and
introducing one more photoluminescent or phosphorescent pigments into the form through the aperture so that they cling to the adhesive on the inner wall, such that the glass form looks like the planet earth when the pigments are glowing.

2. The method of claim 1, wherein a plurality of different pigments are introduced into the form.

3. The method of claim 1, wherein the adhesive is applied with a brush.

4. A gazing globe made in accordance with the method of claim 1.

5. The method of claim 1, including the step of positioning the form with pigments onto a physically separate stand.

6. A glow-in-the-dark gazing globe, comprising:
a hollow, transparent or translucent spherical form having an inner wall; and
one or more photoluminescent or phosphorescent pigments adhesively attached to the inner wall of the form in a pattern that resembles the planet earth.

7. The glow-in-the-dark gazing globe of claim 6, wherein the form is glass or plastic.
